(19) United States
(12) Patent Application Publication
(10) Pub. No.: US 2012/0072898 A1
(43) Pub. Date: Mar. 22, 2012

(54) ON-PREMISE DEPLOYMENT OF VIRTUAL DESKTOP SERVICE SERVERS

(75) Inventors: Jonathan R. Pappas, San Francisco, CA (US); Frank C. Pesek, Emeryville, CA (US)

(73) Assignee: STARTFORCE, INC., San Francisco, CA (US)

(21) Appl. No.: 12/887,398

(22) Filed: Sep. 21, 2010

(51) Int. Cl. G06F 21/00; G06F 15/16; G06F 9/44

(52) U.S. Cl. 717/171; 726/4

(57) ABSTRACT

A license server is used for activating and authorizing operation of software components for providing desktop virtualization service. A service server installed with the software components communicate with the licensing server on a periodic or random basis. The service server is managed by a virtual desktop service provider separate from the developer of the software components for providing desktop virtualization service. If the licensing server does not send any reply messages or sends a reply message including deactivation code to the service server, the service server is disabled. The licensing server may also collect information about the use of service server to determine compliance with licensing restrictions.

### CROSS REFERENCE TO RELATED APPLICATIONS

This application is related to U.S. patent application Ser. No. 12/881,079, filed on Sep. 14, 2010, and titled “Disposable Virtual Desktop for Transient Use by Multiple Users”; and U.S. patent application Ser. No. ______, filed on ______, and titled “Virtual Desktop Service with Targeted Advertisement” (Atty Dkt No. 28169-17159).

### BACKGROUND OF THE INVENTION

1. Field of the Invention

This invention relates generally to desktop virtualization, and more specifically to deployment and management of private servers for providing desktop virtualization services.

2. Description of the Related Art

Desktop virtualization involves storing a logical representation of a personal desktop computer (hereinafter referred to as “desktop”) on remote servers and implementing the functionality of the desktop on the on-premise servers. In many cases, the remote servers implement multiple versions of virtual desktops, where each version of the virtual desktop is individualized for a single user who accesses the on-premise servers via a network. Although specific tasks assigned to the remote servers and the user terminals differ based on implementations, the on-premise servers often perform most of the heavy processing tasks while the user terminals often performs relatively light processing tasks such as generating graphical user interfaces and tracking user input activities. By leveraging the resources of the remote servers, even a thin client device with limited capabilities can perform operations that require high-performance computing devices.

The desktop virtualization has, among others, the following advantages: First, updating and maintaining operations (e.g., installation of updated software) are less time-consuming because these operations can be performed centrally at the remote servers. Second, the recovery operation associated with failed desktops can be performed efficiently because a flawed virtual desktop can be deleted and replaced with a new version of virtual desktop in a relatively small amount of time. Third, the operation of the desktop can be monitored and managed centrally, reducing security risks. The virtual desktop can be shutdown or restarted from a central location in case of a security event. Fourth, the overall cost for purchasing or renting devices can be lowered because low performance user terminals can be deployed even for applications that require high-performance computing devices.

Servers or other components for the desktop virtualization may be publicly shared. The servers or other components may be part of a public service that can be accessed by any users, either paid or unpaid. One way of providing the desktop virtualization service is by using a public cloud or a hybrid cloud where at least part of the computing resources are distributed in a network of servers that are publicly accessible. Such public or hybrid version of the desktop virtualization can beneficially reduce capital investment on hardware equipment and increase utilization of various resources.

However, some desktop virtualization service are provided using private servers or private cloud installed on private premises for reasons such as security or performance. Such desktop virtualization service providers can service a limited number of users belonging to an entity or group. The private servers or private cloud for providing the desktop virtualization service is located on a premise (i.e., on-premise) of an entity. Such private servers or private cloud is not publicly accessible. In such on-premise deployment, the system administrator of the desktop virtualization service provider is responsible for installing software components for providing the desktop virtualization and performing various management tasks associated with the desktop virtualization, including installation of updated software components, since developers of the desktop virtualization software has limited access to the private servers or cloud. The management tasks may consume much time of the system administrator.

Further, the developer of the desktop virtualization software may have limited information about the version of software being deployed in private servers or private cloud. Limited information and access to the private servers renders troubleshooting or other management operations (e.g., enforcement of licensing restrictions) by the developer impracticable or impossible. Hence, in many cases, the developer has to rely on a honor system where the system administer of the private servers or cloud reports usage and deployment of the desktop virtualization software. If the system administer does not report the usage and deployment, the software developer can suffer revenue losses.

### SUMMARY OF THE INVENTION

Embodiments relate to authorizing or managing operations for virtualizing computers in a service computing device by a license computing device. The service computing device receives reply messages from the license computing device to provide services of virtualizing computers for a predetermined amount of time. The service computing device initiates the process of receiving the reply messages by sending request messages to the license computing device. After the license computing device receives the request messages, the license computer device determines whether the service computing device is authorized to continue the services and sends the reply messages if the service computing device is authorized. If the service computing device does not receive the reply messages within the predetermined amount of time, the service computing device is disabled from providing the services. The service computing device may send request messages to the license computer device periodically.

In one embodiment, the service computing device is managed by an administrator of the service computing device whereas the license computing device is managed by an entity entitled to compensation for the use of software components associated with the virtualization of computers. The service computing device may be accessed by the administrator but not the entity entitled to compensation.

In one embodiment, the license computing device adds an information request in one or more of the reply messages to the service computing device. The information request instructs the service computing device to include usage information for monitoring the operations of the service computing device in a subsequent request message. The usage information allows the license computing device to determine if the service computing device is complying with licensing restrictions imposed on the service computing device.

The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a diagram illustrating the architecture of a desktop virtualization system, according to one embodiment.

FIG. 2 is a schematic block diagram of on-premise servers, according to one embodiment.

FIG. 3 is a block diagram of a service server, according to one embodiment.

FIG. 4 is a block diagram illustrating components of a virtual desktop application, according to one embodiment.

FIG. 5 is a block diagram illustrating components of a user terminal, according to one embodiment.

FIG. 6 is a block diagram of a license server, according to one embodiment.

FIG. 7 is a flowchart illustrating an overall process of activating and managing operation of a service server, according to one embodiment.

FIG. 8 is a flowchart illustrating a method of activating the service server, according to one embodiment.

FIG. 9 is an interaction diagram illustrating a method of exchanging messages between the service server and the license server to authorize operations of the service server, according to one embodiment.

FIG. 10 is a diagram illustrating a graphical user interface for managing operations of the service server at the license server, according to one embodiment.

### DETAILED DESCRIPTION OF THE EMBODIMENTS

Reference in the specification to “one embodiment,” “an embodiment” or “the embodiment’ means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, a personal digital assistant (PDA), a cellular telephone or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, flash memory or drives, or any type of media suitable for storing electronic instructions, each coupled to a computer system bus.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Embodiments relate to activating and authorizing the operations of a service computing device for providing desktop virtualization service by periodically receiving authorization messages from a license computing device. The service computing device is managed by a virtual desktop service provider separate from the developer of desktop virtualization program running on the service computing device. The developer of the desktop virtualization program may be given limited access to the service computing device. Embodiments allow collecting usage information from the service computing device and managing its operation without compromising security measures of the service computing device.

A service computing device described herein refers to a computing device (e.g., server) installed with software components for providing desktop virtualization service. The service computing device performs, for example, operations associated with generating data objects for transmission to user terminals, and tracking user input activities at the user terminals. The service computing device may operate in conjunction with other computing devices to provide desktop virtualization service to a plurality of users.

A license computing device described herein refers to a computing device (e.g., server) for enforcing licensing restrictions and facilitating management operations of the service computing devices. The licensing computing device may be accessed and managed by the developer of the desktop virtualization software or other entities entitled to compensation for the use of the desktop virtualization service.

### Architecture of Desktop Virtualization System

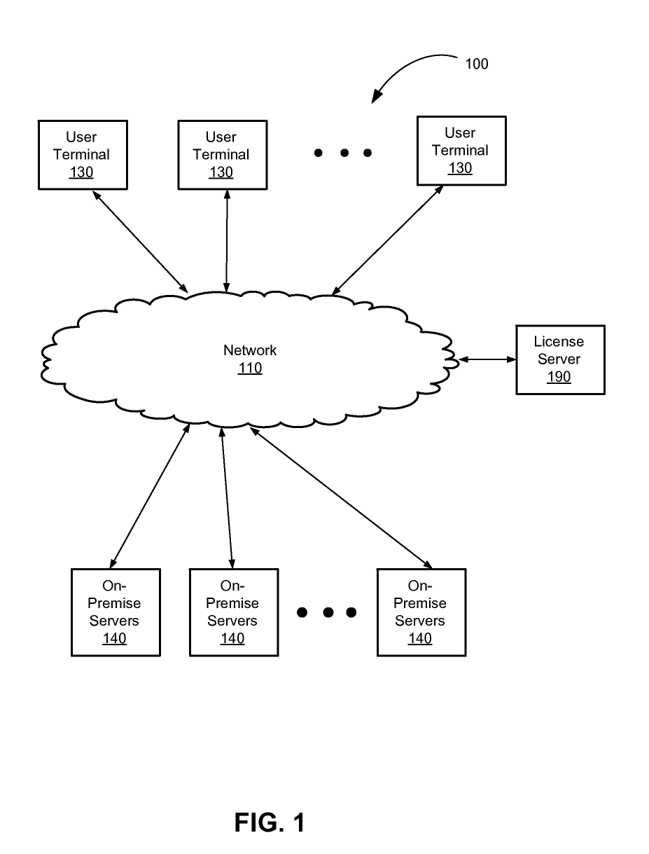

FIG. (FIG. 1 is a diagram illustrating the architecture of a desktop virtualization system 100, according to one embodiment. The desktop virtualization system 100 may include, among other components, a network 110, user terminals 130, on-premise servers 140 and a license server 190. The desktop virtualization system 100 may include components not illustrated in FIG. 1. Further, two or more components illustrated in FIG. 1 may be combined into a single component.

The network 110 allows communication of data between various components of the desktop virtualization system 100. The network 110 may include multiple processing systems and in one embodiment is a network controller. The network of processing systems may comprise a local area network (LAN), a wide area network (WAN) (e.g., the Internet), and/or any other interconnected data paths across which multiple devices may communicate. The network 110 may use standard network protocols such as TCP/IP, HTTP, HTTPS, and SMTP as well as customized network protocols.

The user terminals 130 are computing devices that allow users to access instances of virtual desktops executed and running on the on-premise servers 140. Each of the user terminals 130 includes components for generating and displaying a graphical user interface elements to interact with the user and a networking component to exchange data with other components of the desktop virtualization system 100, as described below in detail with reference to FIG. 5. The user terminals 130 may include, but are not limited to, desktop computers, laptop computers, tablet computers, personal digital assistants (PDAs), cell phones, smartphones, game consoles, set-top boxes, and televisions or other appliances with networking capabilities.

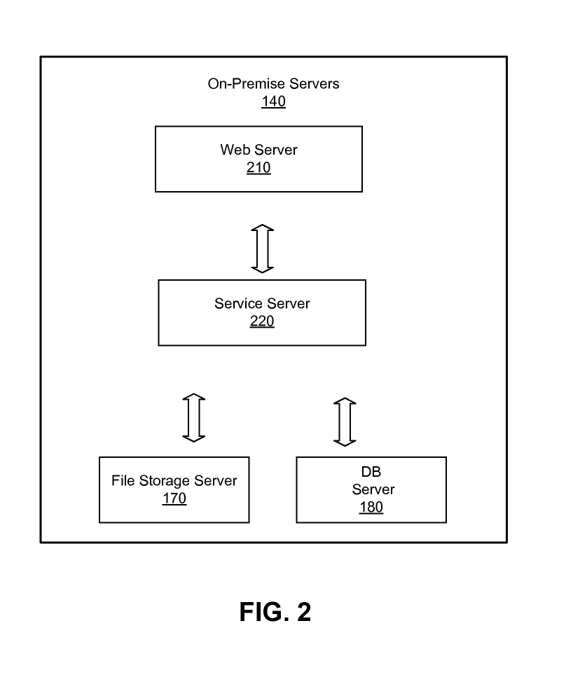

The on-premise servers 140 include one or more servers for providing virtual desktop services that may be accessed via the user terminals 130. The on-premise servers 140 may be located in distinct geographic locations or premises remote from the license server 190. The on-premise servers 140 may include, among other components, a web server, a service server, a file storage server and a database server, as described below in detail with reference to FIG. 2. Functions of the on-premise servers 140 include performing operations associated with instantiating, managing, processing and storing the virtual desktops.

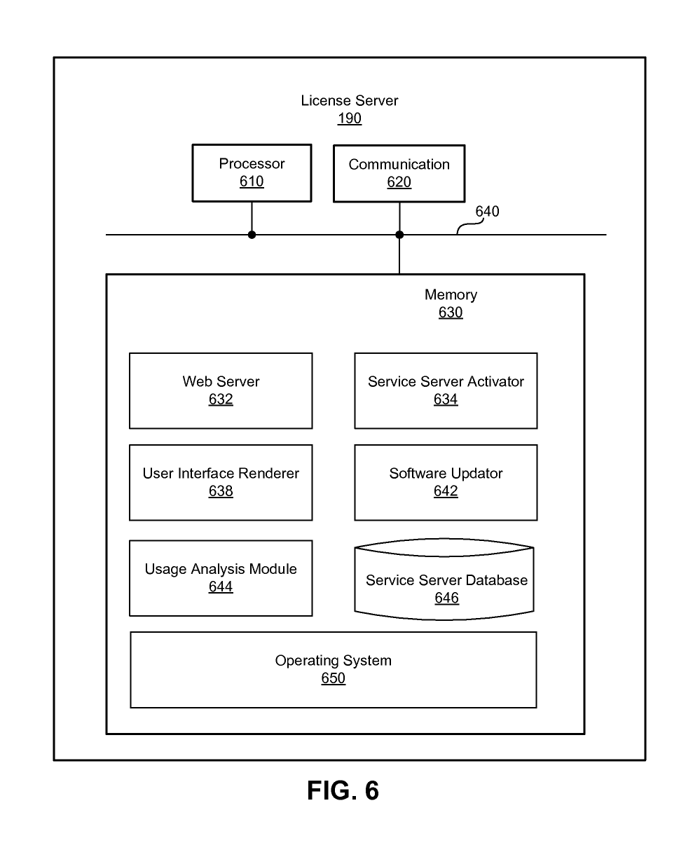

The license server 190 communicates with the on-premise servers 140 to perform, among other operations, the following: (i) authorizing launching of desktop virtualization services, (ii) authorizing continued desktop virtualization services using the on-premise servers 140, (iii) detecting suspicious on-premises servers 140 that may violate licensing restrictions, and (iv) updating software components in the on-premise servers 140, as described below in detail with reference to FIG. 6.

Although the architecture of the virtual desktop system 100 in FIG. 1 has the on-premise servers 140 performing all operations associated with desktop virtualization, some of the functionalities of the on-premise servers 140 may be provided by one or more servers by public servers or other dedicated servers. For example, a separate application server (not shown) may be deployed at locations remote from the on-premise servers 140 to execute certain applications. File servers or database servers may also be deployed at locations different from the on-premise servers 140 to store files and metadata associated with the desktop virtualization. Many combinations of private servers (or private cloud) and public servers (or public cloud) may be employed to provide desktop virtualization service based on requirements associated with scalability, performance, security and cost.

### Architecture and Functions of On-Premise Servers

FIG. 2 is a schematic block diagram of the on-premise servers 140, according to one embodiment. The on-premise servers 140 may include, among other components, a web server 210, a service server 220, a file storage server 170 and a database server 180. Although FIG. 2 illustrates the web server 210, the service server 220, the file storage server 170 and the database server 180 as being embodied on separate physical servers, these servers may also be embodied in a single physical server. Alternatively, some of the web server 210, the service server 220, the file storage server 170 and the database server 180 are located remotely from each other and communicate over the network 110 or other communication channels.

The web server 210 communicates with the service server 220 to transmit data for virtualized desktop to the user terminals 130 over the network 110, and passes information about user input activities at the user terminals 130 to the service server 220. Specifically, the web server 210 communicates data objects generated at the service server 220 to the user terminals 130 over the network 110. Various protocols may be used to communication data between the user terminals 130 and the web server 210.

In one embodiment, the web server 210 uses web-based protocols such as HTTP (Hypertext Transfer Protocol) or its variant (e.g., HTTPS) to communicate with the user terminals 130. Compared to transmitting the pixel-level data over protocols such as RDP (Remote Desktop Protocol) or ICA (Independent Computing Architecture), using the web-based protocols has the following advantages: (i) the web-based protocols enable the web server 210 to communicate data associated with virtual desktops in a bandwidth-efficient manner, (ii) the web-based protocols eliminate or reduce software components that needs to be installed on the user terminals 130, (iii) the web-based protocols enable virtual desktop operations to be performed in a manner that is agnostic to operating systems, (iv) the web-based protocols facilitates development of applications compatible with the virtualization environment, (v) technology related to the web-based protocols are actively being enhanced, and hence, the web-based protocols can leverage various developments in related technology, and (vi) web-based protocols allow graphical user interfaces to be rendered and presented on the user terminals 130 in an efficient manner.

The web server 210 may include, among other components, a processor, a computer-readable storage medium (e.g., RAM (Random Access Memory)) and a communication interface (e.g., network card). The computer-readable storage medium stores computer instructions associated with Web server applications such as IBM WebSphere and Apache Web server that are executed by the processor. The web server 210 may also run middle layer applications to interface with the service server 220 and the user terminals 130.

The service server 220 generates data objects related to virtual desktops for transmission to the user terminals 130 via the web server 210. The service server 220 also received information about user input activities (e.g., clicks of mouse or typing of a keyboard) from the user terminals 130 via the web server 210. Based upon the user input activities, the service server 220 performs various operations associated with the virtual desktops such as moving the location of icons, opening of files, and launching of an application. To perform its operation, the service server 220 may communicate with the application servers (not shown), the file storage server 170 and the database server 180. In one embodiment, the service server 220 is embodied as a server system with desktop virtualization software such as Startforce Server 2010 available from Startforce, Inc. of San Francisco, Calif.

The file storage server 170 stores various files associated with the desktop virtualization. The stored files may include any files uploaded or generated by the users and temporary files generated by the desktop virtualization system 100 during operations associated with virtualization sessions. The service server 220 accesses the files stored in the file storage server 170 to perform various operations. In one embodiment, the file storage server 170 is combined with the database server 180.

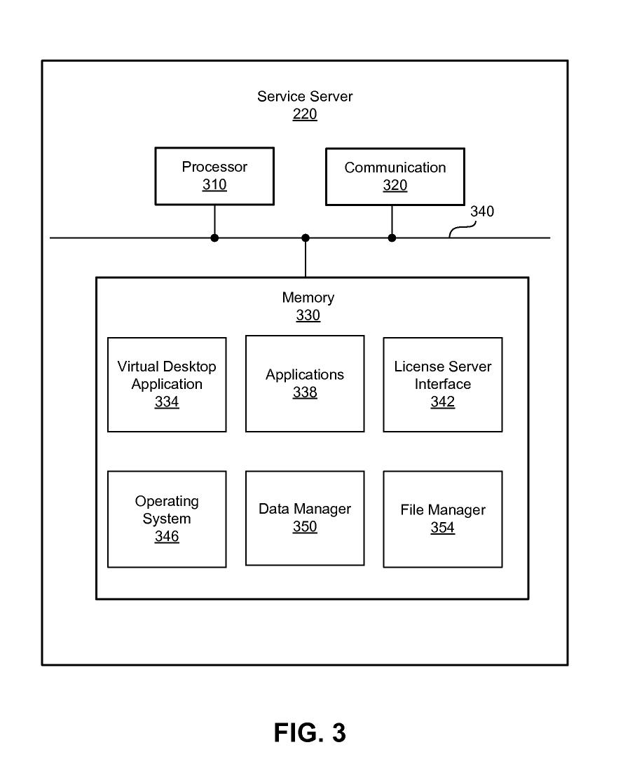

The database server 180 may store data entries associated with, for example, the user profiles, desktop profiles and metadata of the files. The user profiles include information about the user, as described below in detail with reference to FIG. 3. The desktop profile includes information about properties and characteristics of a virtualized desktop for a user, as described below in detail in a subsequent section titled “Desktop Profile.” The metadata in the database server 180 represent information about files stored in the file storage server 170, as described below in detail with reference to FIG. 3. In one embodiment, the database server 180 is embodied as a server running MySQL available from Sun Microsystems of Santa Clara, Calif.

FIG. 3 is a block diagram illustrating the service server 220, according to one embodiment. The service server 220 may include, among other components, a processor 310, a communication module 320, a memory 330 and a bus 340 connecting these components. The processor 310 reads instructions and data from the memory 330 and performs operations. The communication module 320 is hardware, software, firmware or any combinations thereof for communicating with other components of the desktop virtualization system 100 (e.g., user terminals 130 and the license server 190). The service server 220 illustrated in FIG. 3 is merely illustrative. Various other hardware, software or firmware may be provided on the service server 220 to perform additional functions or enhance performance.

The memory 330 is a computer-readable storage medium that stores instruction modules such as a virtual desktop application 334, one or more applications 338, a license server interface 342, an operating system 346, a data manager 350 and a file manager 354. Two or more of these instruction modules may be combined into a single instruction module. Alternatively, one or more of these instructions modules may be divided into smaller instruction modules. Further, some of the instruction modules in FIG. 3 may be stored and executed on other components of the desktop virtualization system 100.

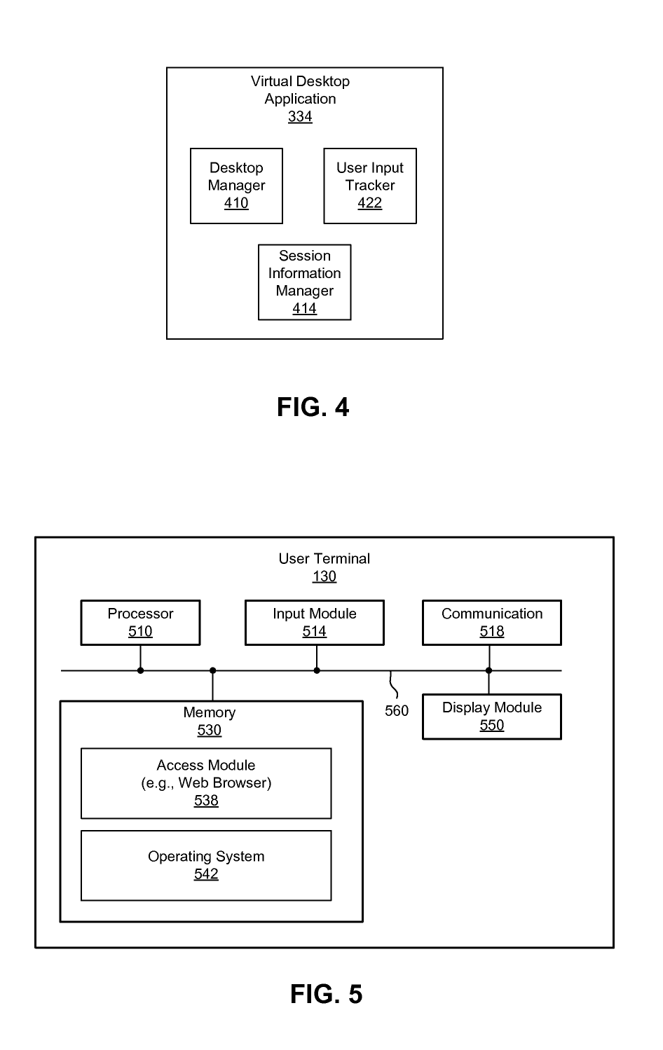

As described below in detail with reference to FIG. 4, the virtual desktop application 334 generates and sends data objects associated with virtual desktops to present graphical representations of the virtual desktops on the user terminals 130 as well as track and detect user input activities on the user terminals 130.

The applications 338 operate in conjunction with the virtual desktop application 334 to perform various operations. The applications 338 may include, for example, text editors, media players, messengers, and file upload/download programs. Users may execute and perform operations based on the applications by interfacing with Startforce API (Application Programming Interface) available from Startforce, Inc. of San Francisco, Calif. In one embodiment, one or more applications may be executed by a separate application server (not illustrated) which may be included or embodied as one of the on-premise servers 140 or a server located remotely from the on-premise servers 140. The service server 220 may communicate with such application servers using protocols such as HTTP, HTTPS, RDP (Remote Desktop Protocol) and ICA (Independent Computing Architecture).

The license server interface 342 communicates with the license server 190 to receive authorization to launch the virtual desktop application 334 or continue operation of the virtual desktop application 334. During installation and activation of the virtual desktop application 334, the license server interface 342 may receive registration information from a system administrator of the on-premise servers 140 and send the information to the license server 190. After installation and activation of the virtual desktop application 334, the license server interface 342 sends requests to the license server 190 for authorization to continue operation of the virtual desktop application 334; and if an authorization reply is not received in response to the request within a predetermined amount of time (e.g., 24 hours), the license server interface 342 disables the virtual desktop application 334 and related software components.

The requests sent by the license server interface 342 may include information such as the IP address of the on-premise servers 140, the identity of the organization or users associated with the on-premise server 140, usage information for monitoring operation of the on-premise server 140, and the current version of the software components installed on the on-premise servers 140.

In one embodiment the requests may be formatted into a HTTP request by the web server 210 for transmission over the network 110 to the license server 190. The requests may also include other information that was previously requested by the license server 190 such as (i) the number of virtual desktops created, (ii) the extent of resources used for desktop virtualization (e.g., memory usage), (iii) the type and extent of files used, and (iv) usage of applications invoked by virtual desktops hosted by the web server 210. Such information may be analysed by the license server 190 to determine actual or suspected violations of licensing restrictions, as described below in detail with reference to FIG. 6.

In one embodiment, the license server interface 342 generates a graphical user interface that is displayed on the web browser of the system administrator when the system administrator attempts to launch the virtual desktop application 334. The system administrator may provide registration information using the graphical user interface. The license server interface 342 sends the registration information to the license server 190.

The license server interface 342 also receives updates to the software components in the memory 330 from the license server 190. In one embodiment, the license server interface 342 sends version information of modules in the virtual desktop applications 334 or the applications 338 to the license server 190. The license server 190 determines if updates to the modules are available, and if so, sends inquiries to the administrator of the on-premise servers 140 for approval to update the modules. If the administrator decides to update the software modules, the license server interface 342 receives the updated modules and installs them. Since the license server 190 receives the version information of the software modules in the service server 220, the license server 190 may update software modules selectively based on availability of updates or approved by the administrator. By updating smaller modules instead of the entire virtual desktop application 334 or related applications, the downtime and resource needed for updating operations can be reduced.

The operating system 346 manages resources of the service server. The operating system 346 may include, for example, Windows Server, Linux, OSX, Solaris 10, Netware, IRIX, and AIX. In one embodiment, the virtual desktop application 334 does not use a hypervisor to provide the desktop virtualization services. Instead, the virtual desktop application 334 uses virtual desktop profiles and web-based protocols to embody virtual desktops, as described below in detail with reference to FIG. 4. By obviating a hypervisor to manage multiple images of operating systems, the performance and scalability of the virtual desktop deployment are increased.

The data manager 350 communicates with the database server 180 to access database entries associated with, among others, the user profiles, the desktop profiles and the file metadata. The user profile may include, for example, the following fields: User ID, user password, user's nickname, user's email address, user's role (e.g., administrator or non-administrator), identification of the organization associated with the user, user's resident address, maximum resources (e.g., communication bandwidth or maximum data storage in the database server 180), previous log-in time or log-out times, whether the user is a paying or free subscriber, and user's ID on social networking services (e.g., Twitter or Facebook). The user profile may be associated with application permission information indicating applications that the user is permitted to access.

The file metadata includes information about a file associated with a user, and may include some or all of the following fields: the name of the file; the user associated with the file; the size of the file; the extension of the file; whether the file indicates a directory or not; whether the file is shared across all or a subset of users; when the file was created, accessed or modified; whether the file counts towards a storage quota assigned to the user; whether the file is encrypted; and a path on the file storage server 170 where the file is stored.

Many advantages of managing the file metadata on the database server 180 separate from the file storage server 170 are as follows: (i) various operations associated with files that do not require actual access to the files can be performed more efficiently and promptly, (ii) the overall size of the data in the database server 180 can be reduced to provide faster overall performance and facilitate various management operations, (iii) statistical analysis for various purposes can be performed more efficiently, and (iv) reduces risks associated with corruption in data entries of the database server 180.

Alternatively, the files can be stored in the database server 180 as blobs instead of being storing in a separate file storage server 170.

### Desktop Profile

Virtualizing a desktop by managing an image of a user's entire software (including the operating system) installed on a desktop may be resource intensive. Hence, instead of creating and managing separate software images for users, embodiments store information about a user's virtualized desktop in a compact desktop profile and user files. The graphical representation of the virtual desktop is generated on the user terminal 130 based on the desktop profiles and the user files. In this way, embodiments achieve virtualization of desktops for multiple users without maintaining the software image of a desktop computer and also without running a resource-intensive hypervisor on the service server 220. As a result, a virtualized desktop account can be set up for a user with only incremental increase in storage requirement.

For example, the additional memory required for an additional user may be as low as 368 Kbytes whereas additional storage space of as much as 5 Gigabytes is required to establish a virtual desktop account in other conventional desktop virtualization systems.

The desktop profiles are stored in the database server 180 and retrieved by the data manager 350. Based on the retrieved desktop profiles, the virtual desktop application 334 instantiates a virtual desktop after receiving a user's request. A desktop profile includes, among other information, the following: (i) information associated with graphical user elements (e.g., icons) to be displayed at the user terminal 130 of the user, such as the identification of the graphical user elements (e.g., an icon representing a document) and their coordinates on a screen or window of the user terminal 130, (ii) user preferences associated with the presented desktop (e.g., background color or image of the virtual desktop screen), (iii) information about association of file types with application programs, (iv) the user's language (e.g., English, Chinese), and (v) application permissions for controlling availability of application to the user.

Example information about the association of file types for a BMP image file, as stored in the desktop profile, is listed in following Table 1.

TABLE 1

| Field | Data type | Examples |
|---|---|---|
| filetype_extension | character | bmp |
| filetype_description | character | BMP Image |
| filetype_icon | character | file_picture.gif |
| Application | character | com_startforce_app_PictureViewer |

Table 1 indicates that the virtual desktop application 334 associates any files with extension of “.bmp” with a BMP image (filetype_description). For files with “.bmp” extension, the virtual desktop application 334 represents this file on a virtual desktop using an icon named “file_picture.gif” Further, when the user attempts to open files with “.bmp” extension (e.g., by double clicking the icon on the user terminal 130), the virtual desktop application 334 launches application “com_startforce_app_PictureViewer” and loads the double-clicked file onto the launched application. Separate tables may be generated and managed for each type of files.

In one embodiment, when a user first logs-on to the on-premise server 140, the user is presented with a graphical user interface screen similar to a desktop window on an operating system such as WINDOWS series operating system (available from Microsoft Corporation of Redmond, Wash.) and OS X operating system (available from Apple Inc. of Cupertino, Calif.) based on the desktop profile. If the user changes the locations of icons, generates or uploads files or changes default applications for launching certain types of files, the desktop profile of the user is updated accordingly and stored in the database server 180 after the user logs off. Hence, when the same user later logs-on, the user is presented with the same graphical user interface screen that was presented to the user before the user logged-off.

### Virtual Desktop Presentation and Interfacing

FIG. 4 is a block diagram illustrating the virtual desktop application 334, according to one embodiment. The virtual desktop application 334 may include, among other components, a desktop manager 410, a user input tracker 422, and a session information manager 414. The virtual desktop application 334 may also include other components for providing additional services to the user.

The desktop manager 410 performs, among other functions, the function of generating data objects and sending the data objects to the user terminal 130 for presentation to the user. When a HTTP request is received from the user terminal 130 via the web server 210, the desktop manager 410 accesses a library to assemble data objects and encode the data objects for transmittal to the user terminal 130. The data objects for transmittal include, for example, window objects, menu objects, theme objects and user session objects, which are processed by the user terminal 130 to render windows, menu items, textual data and other desktop images. In one embodiment, these objects are encoded and packaged as JSON (JavaScript Object Notation) objects. The desktop manager 410 then sends the JSON objects via the web server 210 as a HTTP response.

The following is an example pseudo-code of JSON objects:

{result:[
{“isdir”:true,“ts”:1280241204000,“isencrypted”:0,“pid”:
“m”,“date”:“Tuesday, July 27, 2010
2:33PM”,“size”:0,“id”:“m275328”,“isshared”:false,“owner
name”:“userXYZ”,“name”:“MyMovies”,“owner”:2892,“path”:“”},
{“isdir”:true,“ts”:1280241203000,“isencrypted”:0,“pid”:
“m”,“date”:“Tuesday, July 27, 2010
2:33PM”,“size”:0,“id”:“m275299”,“isshared”:false,“owner
name”:“userXYZ”,“name”:“Desktop”,“owner”:2892,“path”:“”
}
]}

The above pseudo-code is included in a HTTP response from the virtual desktop application 334 generated in response to receiving a HTTP request from the user to open a native application for viewing and navigating through folders and files associated with the virtual desktop. The above pseudo-code includes two JSON objects, one indicating “MyMovies” folder, and another indicating “Desktop” folder. The entire JSON object is delimited by the curly braces (“{”, “}”), and each of the JSON objects is formatted in a name-value pair delimited by curly braces (“{”, “}”). “isdir” field may take a true or false value and indicates whether the data object is associated with a folder or file. “ts” field relates to time stamp indicating the time that the JSON objects were generated, “isencrypted” field takes a true or false value and indicates whether the folder or file is encrypted or not. “pid” field represents a parent entity (e.g., folder) of the JSON object to implement hierarchy of data objects. “date” field indicates the date that the JSON object was originally created. “isshared” field takes a true or false value and indicates whether the folder is shared with other users. “owner name” indicates the user associated with the file (here, the use is “userXYZ”). “name” field indicates the name of the JSON object. “owner” field is followed by a unique number identifying the user. Finally, “path” field indicates the logical path of the file or folder in the virtual desktop (here, both folders are located at root).

The user input tracker 422 operates to receive event information from the user terminal 130 such as clicking of mouse buttons on an icon and typing on a keyboard. The event information may be encoded into JSON objects and then packaged into a HTTP request at the user terminal 130.

The session information manager 414 manages a virtual desktop session with a user by creating and updating session information for each session. The session information is stored in the file storage server 170 and may be accessed to restart a virtual desktop session. The session information may include, for example, the following: (i) IP address of the user terminal 130, (ii) information about programs being used, (iii) the user profile, (iv) web browser of the client terminal 130, (v) currently connected application server or on-premise servers 140, (vi) authentication token and (vii) statistical information such as login time and session length. If a service server 220 handling a user's request becomes inoperable, the session information may be retrieved by another service server 220 to resume the session with the user.

FIG. 5 is a block diagram of the user terminal 130, according to one embodiment. The user terminal 130 may include, among other components, a processor 510, an input module 514, a communication module 518, a memory 530, a display module 550, and a bus connecting these components. The user terminal 130 may include components such as a speaker not illustrated in FIG. 5. The processor 510 executes computer instructions stored in the memory 530 to perform various operations. The input module 514 is hardware, software, firmware or a combination thereof for receiving user input. The input module 514 may include, for example, one or more of mouse, keyboard, keypad, touchscreen and remote controller. The communication module 518 is hardware, software, firmware or a combination thereof for communicating with other components of the desktop virtualization system 100 via the network 110. The display module 550 is hardware, software, firmware or a combination thereof for displaying graphical user interface elements. The display module 550 may include, for example, a graphics processing unit, a display driver and a display screen.

The memory 530 stores software components for operating the user terminal 130. The software components in the memory 530 may include, among other components, an operating system 542 for managing and allocating resources of the user terminal 130 to various operations, and an access module 538 for accessing the virtual desktop instantiated on the service server 220. The memory 530 may store various other software components that are omitted herein for the sake of brevity.

The access module 538 may be embodied as any software for navigating and accessing web-based information from a web server over the network 110. In one embodiment, the access module 538 is embodied as a web browser capable of sending HTTP requests to web servers and receiving HTTP responses from the web servers. Example web browsers include Internet Explorer (IE) (available from Microsoft of Redmond, Wash.), Safari (available from Apple Inc. of Cupertino, Calif.), Mozilla Firefox (available from Mozilla Corporation of Mountain View, Calif.) and Chrome (available from Google Inc. of Mountain View, Calif.). After a user requests a virtual desktop session, the HTTP request is sent to the on-premise servers 140 where the user is authenticated

The access module 538 renders the graphical representation of the virtual desktop by interpreting, for example, a combination of HTML, CSS, JavaScript, images and other related web technology components. In one embodiment, the access module 538 includes a Javascript/Ajax library for handling JSON objects. In response to the HTTP request, the access module 538 receives JSON objects from the on-premise servers 140. The access module 538 parses the received JSON objects, extracts data from the JSON objects, and renders a graphical user interface screen based on the extracted data. Most web browsers are capable of operating with Javascript/Ajax library, and hence, these web browsers can function as the access module 538 without installation of additional software components or with the installation of a small-sized library. Further, similar operations associated with virtualization can be expected from different web browsers because Javascript/Ajax library is accessed and used consistently throughout different web browsers. In one embodiment, Javascript/Ajax library is Startforce Javascript Application Framework available from Startforce, Inc. of San Francisco, Calif.

After an initial virtual desktop screen is presented on the screen of the user terminal 130, the user may perform operations such as launching an application or opening a file. In response to receiving user input for such actions at the input module 514, the access module 538 creates JSON objects based on the Javascript/Ajax library, and sends the created JSON objects to the on-premise servers 140 in a HTTP request. The on-premise servers 140 then perform operations based on the received JSON objects and returns another set of JSON objects for generating an updated graphical user interface screen on the user terminal 130. The access module 538 and the on-premise servers 140 exchange the JSON objects in the form of HTTP requests and HTTP responses to perform operations associated with the virtual desktop.

By communicating high-level JSON objects instead of low-level pixel data, the desktop virtualization system 100 can significantly reduce the bandwidth needed for performing virtual desktop operations. Moreover, the virtual desktop operations may be performed using various web browsers with minimal or no additional software installation.

### Architecture and Function of License Server

FIG. 6 is a block diagram of the license server 190, according to one embodiment. The license server 190 may include, among other components, a processor 610, a communication module 620, a memory 630 and a bus 640 connecting these components. The processor 610 reads instructions and data from the memory 630 and performs operations. The communication module 620 is hardware, software, firmware or any combinations thereof for communicating with other components of the desktop virtualization system 100 (e.g., the on-premise servers 140). The license server 190 of FIG. 6 is merely illustrative. Various other hardware, software or firmware may be provided on the license server 190 to perform additional functions or enhance performance.

The memory 630 is a computer-readable storage medium that stores instruction modules such as web server 632, service server activator 634, user interface renderer 638, software updator 642, usage analysis module 644, service server database 646 and operating system 650. Two or more of these instruction modules may be combined into a single instruction module. Alternatively, one or more of these instructions modules may be divided into smaller instruction modules.

The web server 632 communicates management information to and from the service server 220 over the network 110. The management information includes, but is not limited to, (i) requests from the service server 220 seeking authorization to activate or continue desktop virtualization operations, (ii) usage information for determining compliance with licensing restrictions, (iii) replies to the requests for activation or continuation of desktop virtualization operations, and (iv) software update information. By communicating the management data over the network 110, a software developer or an entity associated with the software developer may perform management operations on the service server 220 and enforce licensing restrictions via the license server 190. In one embodiment, the management information is encrypted.

Various protocols may be used to communicate the management information between the on-premise servers 140 and the web server 632. In one embodiment, the web server 632 uses web-based protocols such as HTTP (Hypertext Transfer Protocol) or its variant (e.g., HTTPS) to communicate with the on-premise servers 140. Each of the requests and the replies may include one or more JSON (JavaScript Object Notation) objects associated with the management information or process.

The service server activator 634 manages the activation of the virtual desktop application 334 and related software components (e.g., the applications 338 and the license server interface 342) on the service server 220. After a system administrator of the on-premise servers 140 installs the virtual desktop application 334 on the service server 220, the license server interface 342 (see FIG. 3) requests information for registration from the system administrator. The registration information may include, for example, the name and email address of the system administrator. The license server interface 342 receives the registration information and sends the registration information to the service server activator 634.

In one embodiment, the service server activator 634 performs operations to confirm the accuracy of the registration information. For example, the service server activator 634 sends an email to the system administrator using the email address provided in the registration information. The email may include a hypertext link for confirming that the system administrator indeed installed the virtual desktop application 334 and is requesting activation of the software. If the system administrator clicks the hypertext link, an initializing HTTP request is sent to the service server activator 634. The initializing HTTP request may cause the license server 190 to list the service server 220 as an authorized service server or service server awaiting authorization from the user of the license server 190.

After receiving the registration information, the service server activator 634 generates an entry in the service server database 646 including the registration information and other information (e.g., IP address of the service server 220) associated with the newly activated service server 220. The service server activator 634 may also store entries for unsuccessful attempts by unauthorized persons to activate the virtual desktop application 334. Entries for unsuccessful attempts may be accessed by the usage analysis module 644 to detect suspicious activities or circumvention of licensing requirements.

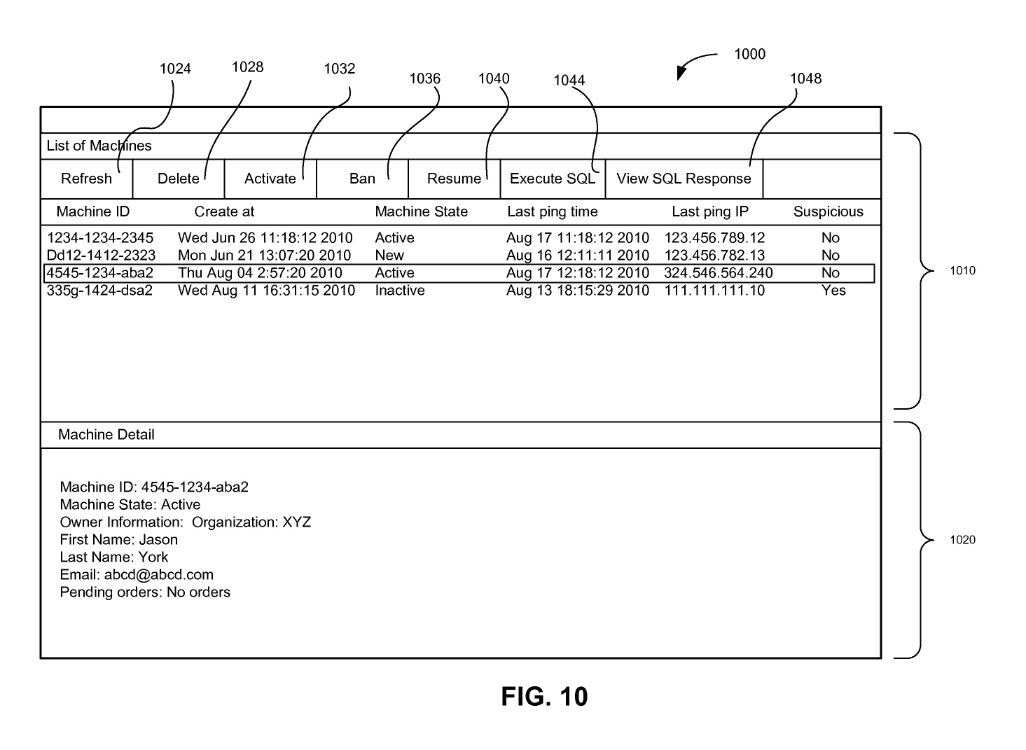

When the service server activator 634 determines that the service server 220 is authorized to start operation, the service server activator 634 responds to the requests for authorization from the service servers 220. After the desktop virtualization operation is initialized, the service server activator 634 receives, periodically (e.g., every 10 minutes) or in a random time interval, requests from the service server 220 seeking authorization to continue desktop virtualization operation. The service server activator 634 may respond to the requests, as described below in detail with reference to FIG. 10.

In one embodiment, the service server activator 634 passively responds to the HTTP requests from the service server 220 instead of initiating communication with the service server 220. Communicating the management information as HTTP requests and responses has the following advantages: (i) issues with network security measure may be avoided or alleviated since HTTP responses to HTTP requests bypasses most network security devices, (ii) spoofing communication to and from the license server 190 can be avoided, (iii) HTTP requests and responses eliminate the requirement of additional network protocol support, and (iv) HTTP communication uses the standard HTTP port (80) which is typically made available by network security administrators. This is also implemented as an outbound-only (from the service server 220) request which adheres to most security and firewall requirements. Firewalls and other network security measures may restrict the service server activator 634 from initiating communication with the service server 220. Hence, the service server activator 634 sends authorization to the service server 220 in the form of a HTTP response as a reply to a HTTP request from the service server 220.

The user interface renderer 638 generates and presents graphical user interfaces associated with the management of desktop virtualization to the user of the license server 190. An example of the graphical user interface is described below in detail with reference to FIG. 10.

The software updator 642 tracks versions of multiple software modules deployed in the service servers 220 and sends updated software modules to the service server 220. The version information of the software modules in the service server 220 may be stored in the entries of the service server database 646. In one embodiment, the software updator 642 sends the updated software modules to the service servers 220 automatically when the updated software modules become available. In another embodiment, the software updator 642 sends the updated software modules to the service servers for deployment when approved by the administrator of the on-premise servers 140.

By tracking the versions of multiple software modules, the software updator 642 may send selected software modules for installation in the service server 220 instead of sending an entire software component for updating. This reduces the bandwidth and downtime needed for installing the software updates.

The usage analysis module 644 analyzes the usage information received from the service servers 220 and determines suspicious activities associated with authorization of the desktop virtualization operations. For this purpose, the usage analysis module 644 may correlate current and past usage information received from the service servers 220. For example, if multiple requests for trial use of the virtual desktop application 334 are received from the same IP address, the usage analysis module 644 may flag such attempts as unauthorized attempts to extend the trial period of the desktop virtualization operations. Additionally, every on-premise installation of a service server 220 initially creates a unique machine identifier (MID). Upon first launching of service server 220, the MID is registered as a new installation with the license server 190. Subsequent attempts to re-register the same MID would be also flagged as a suspicious activity. When a suspicious activity is detected, the usage analysis module 644 may bring the activity to the attention of the user of the license server 190.

The service server database 646 may store, among other information, information associated with the service servers 220. Specifically, the service server database 646 may store one or more of the following: (i) registration information (e.g., email address of the administrator of the service server 220), (ii) the IP address of the service server 220, (iii) license restrictions (e.g., the maximum number of authorized virtualized desktops), (iv) the time previous request for authorization was received, (v) the IP address from which the previous request for authorization originated, (vi) the state of the service server 220 (e.g., active, awaiting authorization and inactive), (vii) the time at which the software components for desktop virtualization was deployed, (viii) the identification number for the service server 220, (ix) usage information for monitoring the operation of the service server 220

In one embodiment, queries may be executed on the date entries stored in the service server database 646. For example, SQL queries may be run on the data stored in the service server database 646. The user of the license server 190 may search and identify a list of service servers that match the criteria to facilitate management operations.

The operating system 650 manages resources for various operations performed on the license server 190. The operating system 650 may include, for example, Windows Server, Linux, OSX, Solaris 10, Netware, IRIX, and AIX.

### Method for Authorizing and Managing Service Server

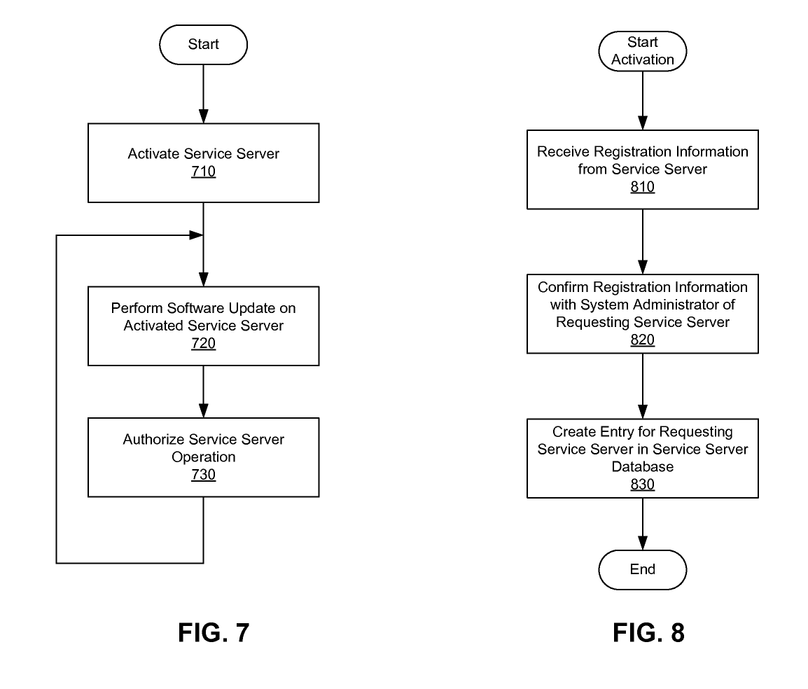

FIG. 7 is a flowchart illustrating an overall process of activating and managing the operation of the service server 220, according to one embodiment. The license server 190 first activates 710 the service server 220 through a registration process, as described below in detail with reference to FIG. 8.

The license server 190 also performs 720 updating of software components deployed in the service server 220. The software update may be an automatic process or a process that requires a manual approval from the administrator of the service server 220. For this purpose, the license server 190 retains information about versions of various software modules deployed in the service server 220 and updates outdated software modules.

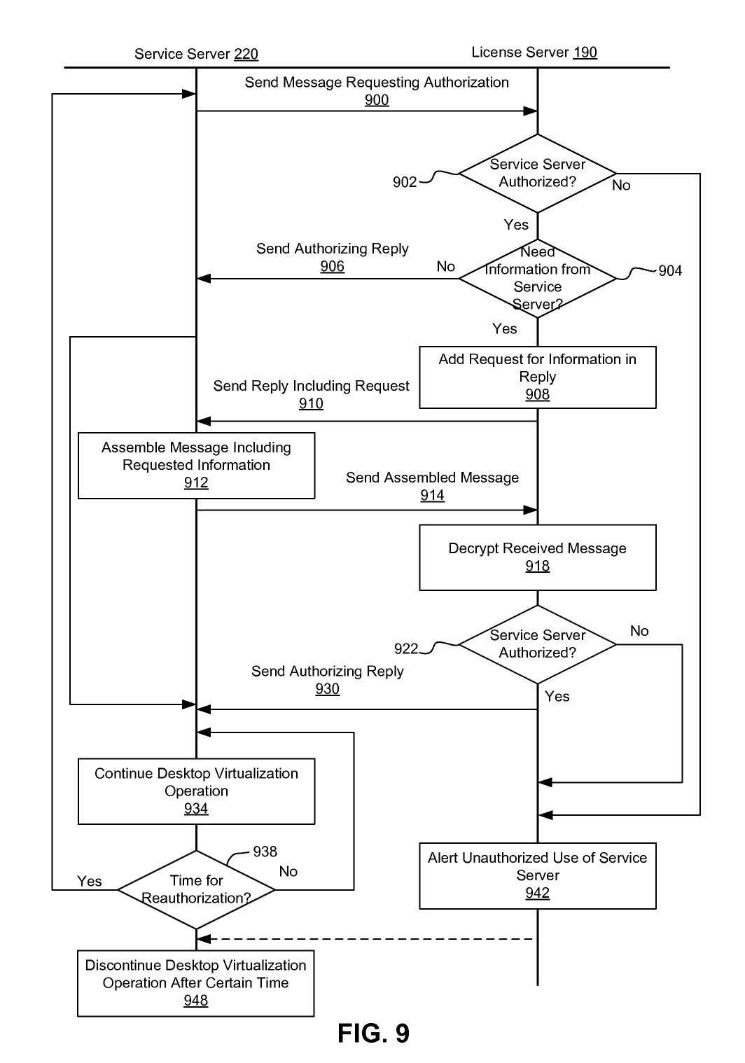

After the service server 220 is activated, the license server 190 continues to send replies in response to receiving authorization requests from the service server 220, as described below in detail with reference to FIG. 9. The authorization requests may be received periodically (e.g., every 10 minutes) or on a random basis. If the license server 190 does not respond to the authorization requests or sends a deactivation code in the reply, the service server 220 or the virtual desktop application 334 is disabled.

The overall process of activating and managing the service server 220 as illustrated in FIG. 7 is merely illustrative. Various changes can be made to the method illustrated in FIG. 7. For example, authorizing 730 the operation of the service server 220 may be performed before performing 720 the software update. Further, updating 720 of the software may be omitted.

FIG. 8 is a flowchart illustrating a method of activating the service server 220, according to one embodiment. During the activation process, the license server 190 receives from the service server 220 the registration information as provided by a system administrator of the service server 220.

Then, the accuracy of the registration information is confirmed 820 with the system administrator of the service server 220. The registration information may be confirmed, for example, by sending an email to the system administrator and receiving a reply (e.g., HTTP request) from the system administrator.

The license server 190 also creates 830 an entry in the service server database 646 that stores information associated with the service server 220. The stored information may be queried and processed to identify service servers matching certain criteria and selecting software modules for updating.

The processes described in FIG. 8 are merely illustrative. Various changes may be made to the processes of FIG. 8. For example, the process of confirming 820 the registration information may be omitted. Further, the entry for the service server database may be created 830 before confirming 820 the registration information.

FIG. 9 is an interaction diagram illustrating a method of exchanging messages between the service server 220 and the license server 190 to authorize the operation of the service server 220, according to one embodiment. The service server 220 sends 900 a message to the license server 190 requesting authorization to continue operations. In response, the license server 190 accesses the service server database 646 to determine 902 if the service server 220 is authorized to provide desktop virtualization services.

If the service server 220 is authorized, the license server 190 then determines 904 if usage information (e.g., the number of virtual desktop accounts created, usage statistics and the memory usage) is needed from the service server in the next message requesting authorization. If no usage information is needed, the service server 220 sends 906 an authorizing reply without any request for usage information. Then service server 220 continues to 934 provide the desktop virtualization operation for a certain amount of time.

In contrast, if the usage information is needed from the service server 220, the license server 190 adds 908 a request for the information in the reply and sends 910 the reply including the request to the service server 220. After receiving the request, the service server 220 assembles 912 a message including the usage information and sends 914 the assembled message to the license server 190 immediately or when it is time to send an authorization request to the license server 190.

The messages from the service server 220 may be encrypted and packaged into a HTTP request. Hence, the license server 190 decrypts 918 the message received from the service server to extract the usage information previously requested from the service server 220. Based partly on the extracted usage information, the license server 190 determines 922 if the service server 220 is authorized to continue the desktop virtualization operation. The license server 190 may determine that the service server 220 is no longer authorized to perform the desktop virtualization operation if the licensing restrictions (e.g., the maximum number of virtualized desktops) are not complied with.

If the service server 220 is not authorized, the license server 190 may either decline to send the authorizing reply or send a reply including a deactivation code for deactivating the service server 220. Further, the license server may alert 942 unauthorized use of the service server 220 to a person responsible for managing virtualization service deployment. If the service server 220 does not receive any replies from the license server 190, the service server 220 discontinues 948 desktop virtualization operations after a certain time (e.g., 24 hours) from the time of last reply.

If it is determined 922 that the service server 220 is authorized, the license server 190 sends 930 an authorizing reply. Based on the received authorizing reply, the service server 220 continues 934 to perform the desktop virtualization operation.

It is then determined 938 if it is time for reauthorization. If it is not yet time for reauthorization, the process returns to continue 934 performing the desktop virtualization operation. In contrast, if it is time for reauthorization, the process returns to sending 900 a message requesting authorization and repeats the subsequent processes.

### Example Graphical User Interface for Managing Service Servers

FIG. 10 is a diagram illustrating graphical user interface 1000 for managing the operations of the service server 200 at the license server 190, according to one embodiment. The graphical user interface 1000 includes two sections: (i) summary section 1010 listing a list of service servers and (ii) detail section 1020 providing detailed information about a service server selected in the summary section.

The summary section 1010 includes command icons for viewing a list of service servers and taking actions on select service servers. The summary section shows brief summary of information: (i) unique identifications for the service servers (“Machine ID”), (ii) the time that the virtual desktop application 334 was installed and created (“Created at”), (iii) the status of the service servers (“Machine State”), (iv) the previous times at which the service servers sent requests for authorization (“last ping time”), (v) the IP addresses of the service servers that requested the authorization (“last ping IP”), and (vi) whether the service server is suspected of unauthorized use (“Suspicious”).

A user accessing the graphical user interface 1000 may use various commands on the listed service servers. By clicking “Refresh” button 1024, the user can refresh the list of service servers displayed on the graphical user interface 1000. The “Delete” button 1028 allows the user to delete the entry for the service server. If the entry is deleted, the license server 190 no longer responds to any authorization request from the deleted service server. Any subsequent authorization requests from a deleted service server would in effect restart the registration process described in FIG. 7. “Activate” button 1032 allows the user to activate the “new” service server or switch a trial service server to an active service server. Conversely, “Ban” button 1036 allows the user to inactivate a selected service server that is currently active. “Resume” button 1040 allows the user to activate an inactivated service server. “Execute SQL” button 1048 allows the user to generate a pending request for usage information from the selected service server. By clicking “View SQL Response” button 1048, the user may view the result of the SQL query received from the service server.

The detail section 1020 displays the details of the service server selected from the list in the summary section 1010. In the example of FIG. 10, detailed information for a service server with ID “4545-1234-aba2” is displayed in the detail section 1020.

The graphical user interface 1000 of FIG. 10 is merely illustrative. Sections other than the summary section 1010 and the detail section 1020 may be displayed on the graphical user interface 1000. Information displayed on each section may also be modified to present information other than what is illustrated in FIG. 10.

### Alternative Embodiments

The foregoing description of the embodiments of the present invention has been presented for the purposes of illustration and description. It is not intended to be exhaustive or to limit the present invention to the precise form disclosed. Many modifications and variations are possible in light of the above teaching. It is intended that the scope of the present invention be limited not by this detailed description, but rather by the claims of this application. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions and/or formats. Furthermore, as will be apparent to one of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

1. A method of authorizing virtualization of computers in a service computing device by a license computing device, comprising:
receiving request messages from the service computing device requesting authorization to initialize or continue virtualization of the computers in the service computing device;
determining whether the service computing device is authorized to continue virtualization of the computers; and
sending reply messages to the service computing device responsive to determining that the service computing device is authorized to continue the virtualization of the computers, each of the reply message authorizing the service computing device to continue the virtualization of the computers for a predetermined amount of time.

2. The method of claim 1, wherein the service computing device is managed by a first entity and the license computing device is managed by a second entity different from the first entity, and wherein the service computing device and the license computing device are remotely located.

3. The method of claim 1, wherein the request messages are received periodically at the license computer device from the service computing device.

4. The method of claim 1, further comprising declining to send subsequent reply messages responsive to determining that the service computing device is not authorized to virtualize the computers, the service computing device discontinuing virtualization of the computers responsive to not receiving the subsequent reply messages within an authorized time period.

5. The method of claim 1, further comprising adding an information request in one or more of the reply messages to the service computing device, the information request instructing the service computing device to include information for monitoring the operations of the service computing device in a subsequent request message.

6. The method of claim 5, further comprising:
extracting the information in the subsequent request message;
determining whether the service computing server is in compliance with one or more license restrictions by analyzing the extracted information; and
determining that the service computing device is not authorized to continue virtualization of computers responsive to the extracted information indicating that the service computing device is not in compliance with the one or more license restrictions.

7. The method of claim 5, wherein the information comprises at least one of a number of virtual computers created in the service computing device and an extent of resources used for the virtualization of the computers in the service computing device.

8. The method of claim 1, wherein the request messages are HTTP (Hypertext Transfer Protocol) requests and the reply messages are HTTP responses.

9. The method of claim 1, further comprising:
storing versions of software components installed in the service computing device;
determining software components for upgrade based on the stored versions of the software components; and
sending, to the service computing device, one or more software components determined for upgrade.

10. The method of claim 1, further comprising:
receiving registration information for the service computing device before initializing the service computing device for the virtualization of the computers;
confirming at least a part of the registration information with an administrator of the service computing device; and
authorizing the initializing of the virtualization responsive to confirming at least a part of the registration information.

11. The method of claim 1, further comprising generating a graphical user interface for activating or deactivating the service computing device.

12. The method of claim 1, further comprising determining a service computing device suspicious of violating license restrictions imposed on the virtualizing operation by analyzing the request messages.

13. The method of claim 1, wherein the service computing device communicates JSON (JavaScript Object Notation) objects in a HTTP protocol with a plurality of user terminals.

14. The method of claim 1, wherein the license server receives the request messages from a plurality of service servers and sends the reply messages to at least part of the plurality of service servers that are authorized for virtualization of the computers.

15. A license computer device for authorizing virtualization of computers in a service computing device, comprising:
a service server activator to determine whether the service computing device is authorized to continue virtualization of the computers; and
a communication module connected to the service server activator, the communication module configured to:
receive request messages from the service computing device requesting authorization to initialize or continue virtualization of the computers in the service computing device; and
send reply messages to the service computing device responsive to determining that the service computing device is authorized to continue virtualization of the computers, each of the reply message authorizing the service computing device to continue the virtualization of the computers for a predetermined amount of time.

16. The license computer device of claim 15, wherein the service computing device is managed by a first entity and the license computing device is managed by a second entity different from the first entity, and wherein the service computing device and the license computing device are remotely located.

17. The license computer device of claim 15, wherein the request messages are received periodically at the license computer device from the service computing device.

18. The license computer device of claim 15, wherein the service server activator is further configured to:
add an information request in one or more of the reply messages to the service computing device, the information request instructing the service computing device to include information for monitoring the operations of the service computing device in a subsequent request message;
extract the information in the subsequent request message;
determine whether the service computing server is in compliance with one or more license restrictions by analyzing the extracted information; and
determine that the service computing device is not authorized to continue virtualization of computers responsive to the extracted information indicating that the service computing device is not in compliance with the one or more license restrictions.

19. The license computer device of claim 1, further comprising a web server connected to the service server activator, the web server configured to:
decode HTTP requests from the service computing device to extract the request messages; and
encode the reply messages in HTTP responses for sending to the service computing device.

20. A computer-readable storage medium storing instructions thereon, the instructions when executed by a processor in a license computing device, cause the processor to:
receive request messages from a service computing device requesting authorization to initialize or continue virtualization of computers in the service computing device;
determine whether the service computing device is authorized to continue virtualization of the computers; and
send reply messages to the service computing device responsive to determining that the service computing device is authorized to continue the virtualization of the computers, each of the reply message authorizing the service computing device to continue the virtualization of the computers for a predetermined amount of time.
